(19) United States
(12) Patent Application Publication
(10) Pub. No.: US 2019/0136989 A1
(43) Pub. Date: May 9, 2019

(54) FLOW PATH SWITCHING VALVE

(71) Applicants: DENSO CORPORATION, Kariya-city, Aichi-pref. (JP); TOYOTA JIDOSHA KABUSHIKI KAISHA, Toyota-shi, Aichi-ken (JP)

(72) Inventors: Tamaki SUZUKI, Kariya-city (JP); Nobuyuki HASHIMURA, Kariya-city (JP); Tadao SHIMIZU, Kariya-city (JP); Hirofumi KANAZAWA, Toyota-city (JP)

(73) Assignees: DENSO CORPORATION, Kariya-city, Aichi-pref. (JP); TOYOTA JIDOSHA KABUSHIKI KAISHA, Toyota-shi, Aichi-ken (JP)

(21) Appl. No.: 16/309,703

(22) PCT Filed: May 18, 2017
(86) PCT No.: PCT/JP2017/018715

§ 371 Date: Dec. 13, 2018

(30) Foreign Application Priority Data
Jun. 17, 2016 (JP) 2016-120627

(51) Int. Cl. F16K 11/085

(52) U.S. Cl. CPC F16K 11/0853

(57) ABSTRACT

A flow path switching valve includes a rotatable portion, a packing portion and a valve main body. The valve main body includes: a valve chamber that receives the rotatable portion and the packing portion; an inflow hole; and an outflow hole. The packing portion is configured to be positioned at a predetermined position, at which the packing portion closes an outflow-hole opening end of the outflow hole, in response to rotation of the rotatable portion. When the packing portion is positioned at the predetermined position, the packing portion is urged against a main-body seal portion in a radial direction of a valve axis by a pressure of fluid in the valve chamber, which is higher than a pressure in the outflow hole.

### CROSS REFERENCE TO RELATED APPLICATION

This application is based on and incorporates herein by reference Japanese Patent Application No. 2016-120627 filed on Jun. 17, 2016.

### TECHNICAL FIELD

The present disclosure relates to a flow path switching valve that is configured to switch a flow path, through which fluid flows, or to open and close the flow path.

### BACKGROUND ART

As the flow path switching valve of the above-described type, there is previously known a flow path switching valve recited in, for example, the patent literature 1. The flow path switching valve recited in the patent literature 1 is a three-way rotary valve. The flow path switching valve of the patent literature 1 includes: a valve main body that includes a valve chamber communicated with an inlet port and two outlet ports; a valve element that is made of elastomer; and a valve holder that supports the valve element. The valve element is rotated integrally with the valve holder to selectively close one of the outlet ports. The valve element completely closes the outlet port in a state where the valve element is urged against a valve seat by a resilient force of the valve element.

The valve element is shaped into a hollow elliptical column form. Therefore, a rotational drive force, which is required to rotate the valve element and the valve holder, can be limited to a relative low value, and leakage, which would be caused by, for example, a foreign object, at the valve closing time of the valve element can be limited.

### CITATION LIST

### Patent Literature

PATENT LITERATURE 1: JP2013-57352A

### SUMMARY OF INVENTION

At the flow path switching valve of the patent literature 1, the urging force of the valve element for closing the outlet port is ensured through resilient deformation of the valve element that is made of the elastomer, and thereby, a gap between the valve element and the valve seat is sealed. The urging force of the valve element may possibly be deteriorated due to variations of the respective components or deteriorations of the respective components. Therefore, a designed target value of the urging force is set in view of the amount of reduction in the urging force caused by the variations of the respective components or the deteriorations of the respective components. Specifically, the designed target value of the urging force is set to a value that is obtained by adding the amount of reduction in the urging force discussed above to the required urging force that is required to seal between the valve element and the valve seat.

Thus, in the flow path switching valve of the patent literature 1, the valve element and the valve holder are driven to rotate in the state where the excessive urging force is always applied to the valve element. Therefore, the rotational drive force, which rotates the valve element and the valve holder, is required to be wastefully large. As a result of detailed study of the inventors of the present application, the above point is found.

The present disclosure addresses the above point, and it is an objective of the present disclosure to provide a flow path switching valve that does not need to wastefully increase the rotational drive force, which rotates the valve element and the valve holder.

In order to achieve the above objective, according to an aspect of the present disclosure, there is provided a flow path switching valve that is a rotary valve and is configured to switch a flow path, through which fluid flows, or to open and close the flow path, including:
a rotatable portion that is configured to rotate about a valve axis;
a packing portion that is supported by the rotatable portion while the packing portion is not rotatable relative to the rotatable portion; and
a valve main body that includes:
   a valve chamber that receives the rotatable portion and the packing portion;
   an inflow hole that is communicated with the valve chamber and is configured to input the fluid into the valve chamber; and
   an outflow hole that is communicated with the valve chamber and is configured to output the fluid from the valve chamber, wherein:
the valve main body includes a valve-chamber outer peripheral portion that surrounds the valve chamber about the valve axis;
the outflow hole has an outflow-hole opening end that is opened to the valve chamber at a part of the valve-chamber outer peripheral portion;
the valve-chamber outer peripheral portion includes a main-body seal portion that extends to surround the outflow-hole opening end and is exposed in an inside of the valve chamber;
the packing portion is configured to be positioned at a predetermined position, at which the packing portion closes the outflow-hole opening end, in response to rotation of the rotatable portion; and
the packing portion is configured to be urged against the main-body seal portion in a radial direction of the valve axis by a pressure of the fluid in the valve chamber, which is higher than a pressure in the outflow hole, when the packing portion is positioned at the predetermined position.

As discussed above, the packing portion is configured to be urged against the main-body seal portion in the radial direction of the valve axis by the pressure of the fluid in the valve chamber, which is higher than the pressure in the outflow hole, when the packing portion is positioned at the predetermined position, at which the packing portion closes the outflow-hole opening end. Specifically, the urging force, which urges the packing portion against the main-body seal portion at the time of closing the outflow-hole opening end, is not increased or decreased in response to the resilient deformation of the packing portion. Therefore, it is less necessary to consider the variations or deteriorations of the respective components, such as the packing portion, to avoid the decrease in the urging force. Thus, it is not required to wastefully increase the rotational drive force that rotates the rotatable portion (for example, corresponding to the valve holder discussed above) and the packing portion (for example, corresponding to the valve element discussed above).

### BRIEF DESCRIPTION OF DRAWINGS

FIG. 1 is a perspective view of a flow path switching valve according to a first embodiment, showing an internal structure of the flow path switching valve by partially fragmenting the flow path switching valve.

FIG. 2 is a cross-sectional view of the flow path switching valve of the first embodiment taken along a plane that is perpendicular to a valve axis.

FIG. 3 is a cross-sectional view taken along line III-III in FIG. 2, i.e., a cross-sectional view taken along a plane that includes the valve axis.

FIG. 4 is a perspective view of a first seal member of the flow path switching valve of the first embodiment alone, showing the first seal member viewed from an inside of the first seal member in a radial direction of the valve axis.

FIG. 5 is a perspective view of a packing member of the flow path switching valve of the first embodiment alone, showing the packing member viewed from an outside of the packing member in the radial direction of the valve axis.

FIG. 6 is a cross-sectional view taken along line VI-VI in FIG. 3.

FIG. 7 is a cross-sectional view taken along line VII-VII in FIG. 3, showing a state where a first outflow-hole opening end begins to open through rotation of a packing from a first predetermined position toward one side in a valve circumferential direction.

FIG. 8 is a partial enlarged view of a portion VIII in FIG. 2.

### DESCRIPTION OF EMBODIMENTS

Embodiments of the present disclosure will be described with reference to the drawings. In each of the following embodiments including other embodiments described later, the same or equivalent parts are indicated by the same reference signs.

### First Embodiment

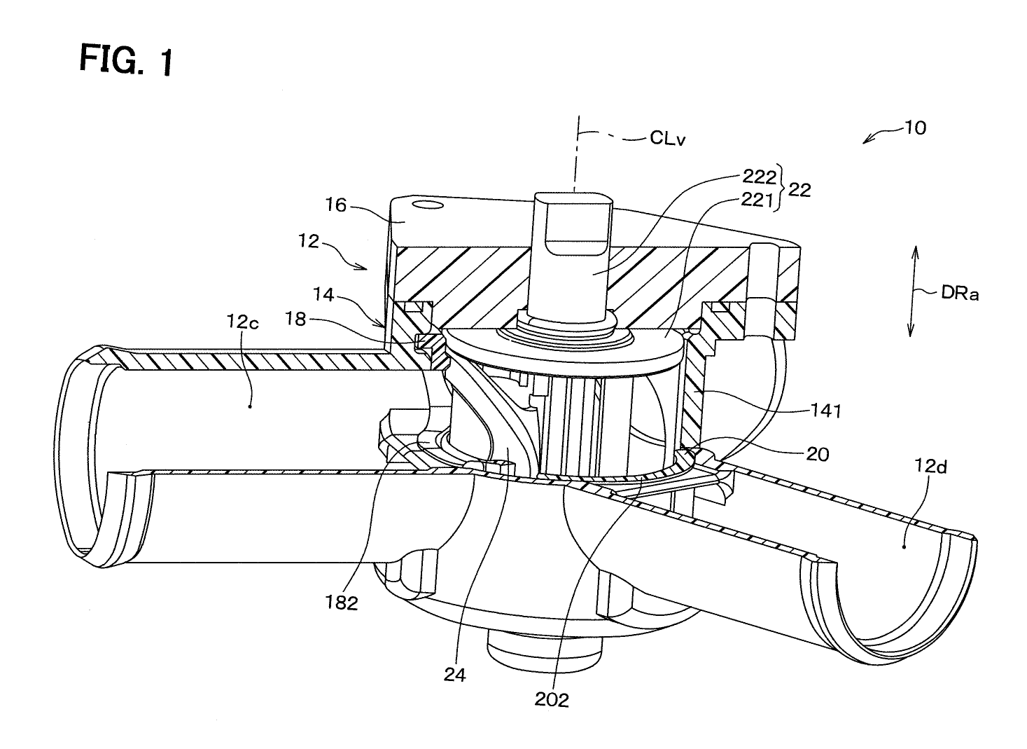

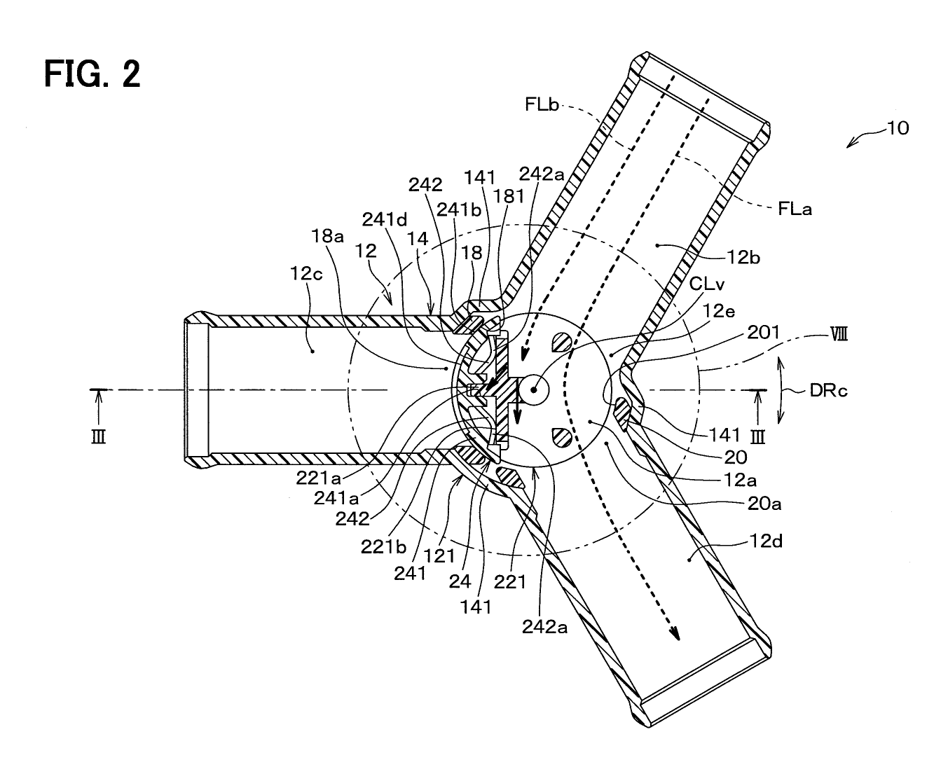

As shown in FIGS. 1 and 2, a flow path switching valve 10 is a rotary valve and is configured to switch a flow path that conducts fluid. Specifically, the flow path switching valve 10 is a rotary three-way valve. The fluid, which flows through the flow path switching valve 10, i.e., the flowing fluid is liquid in this specific example. The flow path switching valve 10 includes a valve main body 12, a controller member 22 and a packing member 24.

The valve main body 12 includes a body member 14, a cover member 16 and two seal members 18, 20. For example, the body member 14, the cover member 16 and the two seal members 18, 20 are respectively made of resin.

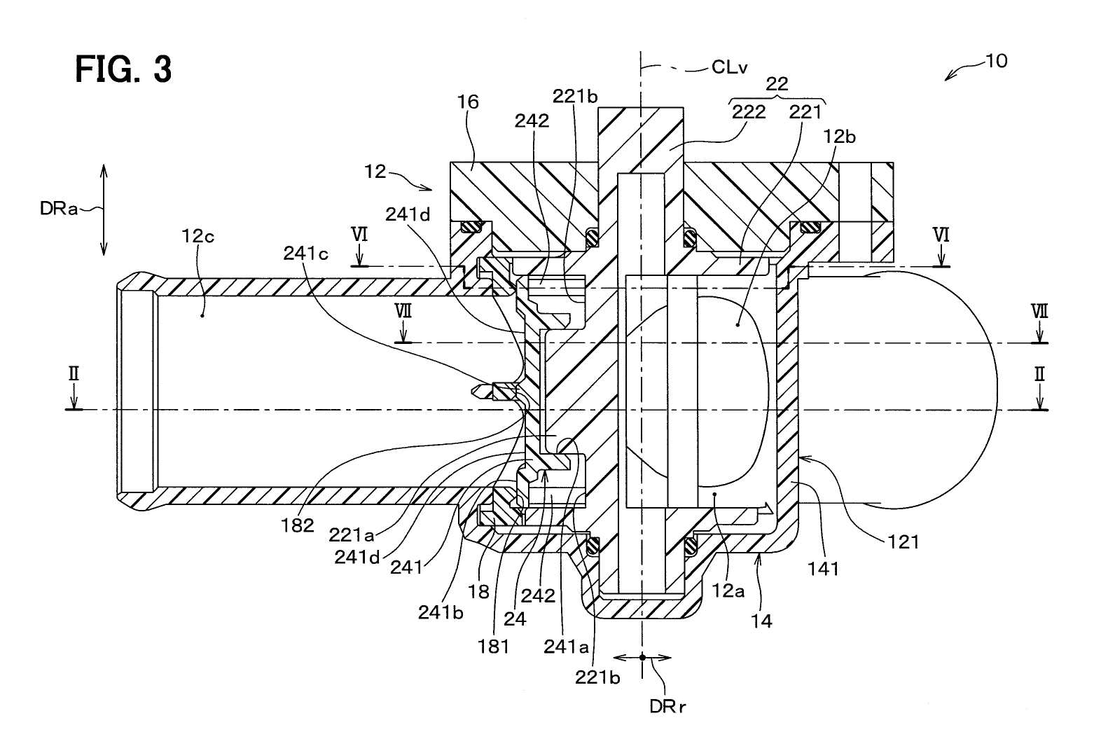

As shown in FIGS. 2 and 3, the valve main body 12 includes a valve chamber 12a, an inflow hole 12b, a first outflow hole 12c and a second outflow hole 12d. Specifically, the valve chamber 12a is mainly made in the body member 14 in the valve main body 12, and one end of the valve chamber 12a located on one side in the axial direction DRa of the valve axis CLv is closed by the cover member 16.

FIG. 2 is a cross sectional view specifically taken along line II-II in FIG. 3. The valve axis CLv is a rotational axis of the controller member 22. In the following description, the axial direction DRa of the valve axis CLv is also referred to as a valve axial direction DRa.

The body member 14 includes a valve chamber outer peripheral wall 141 that extends in a cylindrical form about the valve axis CLv and surrounds the valve chamber 12a. The cover member 16 is fixed to the body member 14 by, for example, bolts.

The inflow hole 12b, the first outflow hole 12c and the second outflow hole 12d are formed at the body member 14 in the valve main body 12 such that the inflow hole 12b, the first outflow hole 12c and the second outflow hole 12d extend through the valve chamber outer peripheral wall 141 and are communicated with the valve chamber 12a. The inflow hole 12b, the first outflow hole 12c and the second outflow hole 12d radially extend from the valve chamber 12a about the valve axis CLv. For instance, the inflow hole 12b, the first outflow hole 12c and the second outflow hole 12d are arranged one after the other at equal angular pitches (specifically, 120 degree pitches) in the circumferential direction about, for example, the valve axis CLv.

The inflow hole 12b is formed as an inlet port of the flow path switching valve 10 and functions as a flow path that conducts the flowing fluid, which is received from the outside of the flow path switching valve 10, into the valve chamber 12a. The first outflow hole 12c is formed as a first outlet port of the flow path switching valve 10, and the second outflow hole 12d is formed as a second outlet port of the flow path switching valve 10. The first outflow hole 12c and the second outflow hole 12d function as flow paths, respectively, which output the flowing fluid from the valve chamber 12a to the outside of the flow path switching valve 10.

Now, connecting subjects, which are configured to be connected with the flow path switching valve 10, are exemplified. Specifically, for example, the inflow hole 12b of the flow path switching valve 10 is connected to a discharge outlet of a pump that discharges the flowing fluid. The first outflow hole 12c is connected to a suction inlet of the pump through a first supply subject device that is a supply destination, to which the flowing fluid is supplied, and the second outflow hole 12d is connected to the suction inlet of the pump through a second supply subject device.

Therefore, in a case where the flowing fluid flows in the flow path switching valve 10, when the second outflow hole 12d is opened upon closing of the first outflow hole 12c, a valve chamber internal pressure, which is a pressure of the flowing fluid in the valve chamber 12a, becomes higher than a first outflow hole internal pressure that is a pressure in the first outflow hole 12c. In contrast, when the first outflow hole 12c is opened upon closing of the second outflow hole 12d, the valve chamber internal pressure becomes higher than a second outflow hole internal pressure that is a pressure in the second outflow hole 12d.

The two seal members 18, 20 are respectively fixed to an inner peripheral side of the valve chamber outer peripheral wall 141 that is shaped into a substantially cylindrical form. Therefore, the two seal members 18, 20 and the valve chamber outer peripheral wall 141 as a whole form a valve-chamber outer peripheral portion 121 that surrounds the valve chamber 12a about the valve axis CLv.

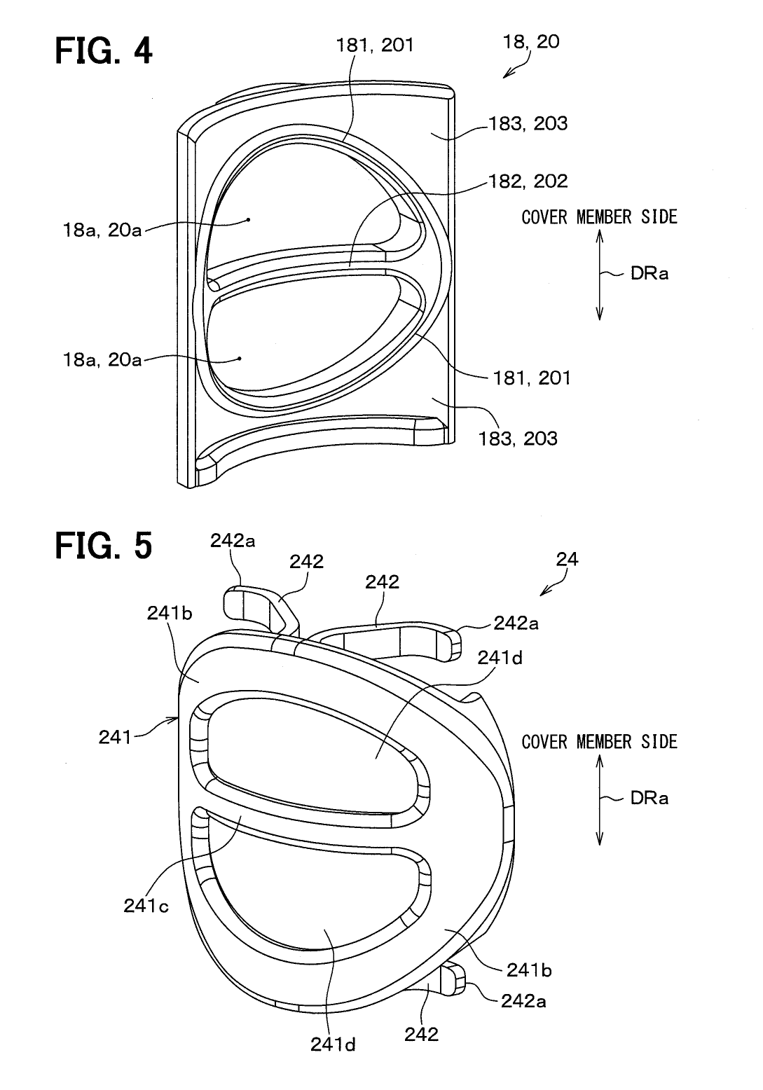

The first seal member 18, which is one of the two seal members 18, 20, is fixed to the inner peripheral side of the valve chamber outer peripheral wall 141. Therefore, as shown in FIG. 4, the first seal member 18 is shaped into a curved form that is curved along the valve chamber outer peripheral wall 141. The first seal member 18 is shaped into a substantially plate form, a thickness direction of which coincides with the radial direction DRr of the valve axis CLv. In the following description, the radial direction DRr of the valve axis CLv will be also referred to as a valve radial direction DRr.

Furthermore, as shown in FIGS. 2 to 4, the first seal member 18 is placed at a location where the first outflow hole 12c is communicated with the valve chamber 12a, and a through-hole 18a extends through the first seal member 18 in the radial direction DRr of the valve axis CLv. The through-hole 18a forms a first outflow-hole opening end 18a as a portion of the first outflow hole 12c. Specifically, the first outflow-hole opening end 18a of the first outflow hole 12c is opened to the valve chamber 12a at the first seal member 18 that is a part of the valve-chamber outer peripheral portion 121.

The first seal member 18 includes: a first main-body seal portion 181, which is shaped into a ring form to surround the first outflow-hole opening end 18a; and a first seal inside portion 182, which is placed in an inside of the first main-body seal portion 181 that is shaped into the ring form. The first main-body seal portion 181 and the first seal inside portion 182 inwardly project in the valve radial direction DRr. The first seal inside portion 182 is formed to extend in a circumferential direction DRc of the valve axis CLv, i.e., a valve circumferential direction DRc and divides the first outflow-hole opening end 18a into two parts in the valve axial direction DRa. The first main-body seal portion 181 and the first seal inside portion 182 are exposed in the valve chamber 12a.

The second seal member 20, which is the other one of the two seal members 18, 20, has the same structure as that of the first seal member 18 but is different from the first seal member 18 in that the second seal member 20 is placed at a location where the second outflow hole 12d is communicated with the valve chamber 12a. Therefore, the through-hole 20a of the second seal member 20 serves as a portion of the second outflow hole 12d to form a second outflow-hole opening end 20a. Specifically, the second outflow-hole opening end 20a of the second outflow hole 12d is opened to the valve chamber 12a at the second seal member 20 that is a part of the valve-chamber outer peripheral portion 121.

Furthermore, the second seal member 20 includes: a second main-body seal portion 201 that corresponds to the first main-body seal portion 181; and a second seal inside portion 202 that corresponds to the first seal inside portion 182. Although FIG. 4 is a diagram showing the first seal member 18, each corresponding one of the reference signs of the corresponding parts the second seal member 20 is also indicated after the corresponding reference sign of the first seal member 18 in FIG. 4.

As shown in FIGS. 2 and 3, the inflow hole 12b of the valve main body 12 has an inflow-hole opening end 12e that is opened to the valve chamber 12a. At a connection where the inflow hole 12b is communicated with the valve chamber 12a, a member, which corresponds to the seal members 18, 20, is not provided unlike the outflow holes 12c, 12d. Therefore, the inflow-hole opening end 12e is formed at the valve chamber outer peripheral wall 141 of the body member 14. The inflow-hole opening end 12e, the first outflow-hole opening end 18a and the second outflow-hole opening end 20a are respectively arranged at different circumferential locations of the valve-chamber outer peripheral portion 121 in the valve circumferential direction DRc.

The controller member 22 is made of, for example, resin and is rotatable about the valve axis CLv. The controller member 22 includes a rotatable portion 221 and a drive shaft portion 222, which are formed integrally in one piece.

The drive shaft portion 222 is a rotatable shaft that transmits a rotational drive force of an undepicted drive source (e.g., an electric motor) to the rotatable portion 221. The drive shaft portion 222 is formed such that a central axis of the drive shaft portion 222 coincides with the valve axis CLv, and the drive shaft portion 222 projects from the rotatable portion 221 at two opposite sides, which are opposite to each other in the valve axial direction DRa. At the one side of the drive shaft portion 222, which is located at the one side in the valve axial direction DRa, the drive shaft portion 222 is rotatably supported by the cover member 16. Furthermore, at the other side of the drive shaft portion 222, which is located at the other side in the valve axial direction DRa, the drive shaft portion 222 is rotatably supported by the body member 14. Furthermore, at the one side of the drive shaft portion 222, the drive shaft portion 222 is connected to the drive source in a manner that enables transmission of the drive force.

The rotatable portion 221 of the controller member 22 is a portion that supports the packing member 24. The rotatable portion 221 and the packing member 24 are received in the valve chamber 12a.

The packing member 24 includes: the packing portion 241 that forms an outer portion of the packing member 24, which is placed at an outer side in the valve radial direction DRr; and an urging portion 242 that is placed on an inner side of the packing portion 241 in the valve radial direction DRr. The packing member 24 is made of resin, such as POM resin, and the packing portion 241 and the urging portion 242 are integrally molded in one piece. The packing member 24 is held between the valve-chamber outer peripheral portion 121 and the rotatable portion 221 of the controller member 22 in the valve radial direction DRr, so that the position of the packing member 24 in the valve radial direction DRr is limited.

An opening degree of each of the outflow holes 12c, 12d, which is opened by the packing portion 241, is adjusted through rotation of the rotatable portion 221, so that the rotatable portion 221 has a flow rate adjusting function for adjusting the flow rate of the flowing fluid that flows into the respective outflow holes 12c, 12d. Furthermore, the packing portion 241 has a seal function for closing the outflow-hole opening end 18a, 20a of the respective outflow holes 12c, 12d.

As shown in FIGS. 2 and 5, the packing portion 241 is curved along the first main-body seal portion 181 and the second main-body seal portion 201.

The packing portion 241 can be positioned at a position where the packing portion 241 is opposed to the first main-body seal portion 181 in the valve radial direction DRr in response to the rotation of the controller member 22. In such a case, the packing portion 241 is opposed to the first main-body seal portion 181 in the valve radial direction DRr and covers the first outflow-hole opening end 18a to close the first outflow-hole opening end 18a.

Furthermore, the packing portion 241 can be positioned at a position where the packing portion 241 is opposed to the second main-body seal portion 201 in the valve radial direction DRr in response to the rotation of the controller member 22. In such a case, the packing portion 241 is opposed to the second main-body seal portion 201 in the valve radial direction DRr and covers the second outflow-hole opening end 20a to close the second outflow-hole opening end 20a.

As shown in FIGS. 2 and 3, the rotatable portion 221 of the controller member 22 includes an engaging portion 221a that outwardly projects in the radial direction DRr. The engaging portion 221a is shaped into a plate form (in other words, a rib form) that extends in the valve axial direction DRa while a thickness direction of this plate form coincides with the valve circumferential direction DRc. The packing portion 241 of the packing member 24 has a fitting hole 241a that is a blind hole, which inwardly opens in the valve radial direction DRr. The engaging portion 221a of the rotatable portion 221 is fitted into the fitting hole 241a. In this way, the packing member 24 is engaged to the engaging portion 221a of the rotatable portion 221, so that the packing member 24 is supported by the rotatable portion 221 in such a manner that the packing member 24 is not rotatable relative to the rotatable portion 221. Specifically, the engaging portion 221a rotates the packing member 24 in response to the rotation of the controller member 22, so that the controller member 22 and the packing member 24 are both rotated about the valve axis CLv.

Furthermore, as recited above, although the position of the packing member 24 in the valve radial direction DRr is limited, the packing member 24 is not fixed to the rotatable portion 221. Specifically, the rotatable portion 221 of the controller member 22 supports the packing portion 241 of the packing member 24 in such a manner that the relative movement of the packing portion 241 relative to the rotatable portion 221 in the valve radial direction DRr is enabled to some extent. Therefore, as long as the urging force of the urging portion 242 and the pressure of the flowing fluid are not applied to the packing portion 241, the packing portion 241 can be moved in the valve radial direction DRr to some extent to closely contact against or move away from the first main-body seal portion 181 or the second main-body seal portion 201.

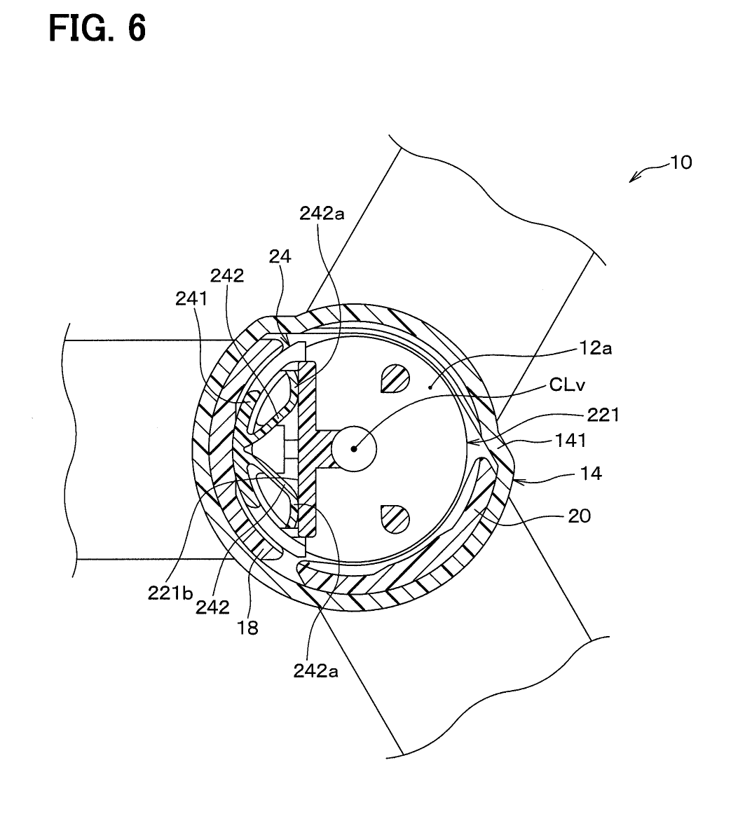

The rotatable portion 221 of the controller member 22 has a receiving surface 221b that is placed on the inner side of the packing portion 241 in the valve radial direction DRr and is opposed to the packing portion 241 in the valve radial direction DRr. The urging portion 242 of the packing member 24 has flexibility and extends from the packing portion 241, as indicated in FIGS. 2 and 6. The urging portion 242 contacts the receiving surface 221b of the rotatable portion 221 through distal end parts 242a, which are located on the opposite side that is opposite from the packing portion 241, so that the urging portion 242 is resiliently deformed. In this way, the urging portion 242 outwardly urges the packing portion 241 in the valve radial direction DRr.

For example, in a case where the packing portion 241 is positioned at a first predetermined position discussed later, the urging portion 242 urges the packing portion 241 against the first main-body seal portion 181, so that the packing portion 241 contacts the first main-body seal portion 181. For example, in another case where the packing portion 241 is positioned at a second predetermined position discussed later, the urging portion 242 urges the packing portion 241 against the second main-body seal portion 201, so that the packing portion 241 contacts the second main-body seal portion 201.

With reference to FIGS. 2 and 3, the flow path switching valve 10 is the three-way valve, and thereby the packing portion 241 is positionable at each of the first predetermined position, at which the packing portion 241 closes the first outflow-hole opening end 18a, and the second predetermined position, at which the packing portion 241 closes the second outflow-hole opening end 20a, in response to the rotation of the controller member 22. That is, the packing portion 241 is configured to selectively close the first outflow-hole opening end 18a and the second outflow-hole opening end 20a. FIGS. 1 to 3 respectively show the state where the packing portion 241 is positioned at the first predetermined position.

In the case where the packing portion 241 is positioned at the first predetermined position in response to the rotation of the controller member 22, the valve chamber internal pressure becomes higher than the first outflow hole internal pressure, as discussed above. Therefore, in the case where the packing portion 241 is positioned at the first predetermined position, the packing portion 241 is urged against the first main-body seal portion 181 by the valve chamber internal pressure. Specifically, the packing portion 241 is urged against the first main-body seal portion 181 by a differential pressure between the first outflow hole internal pressure and the valve chamber internal pressure, so that the packing portion 241 closely contacts the first main-body seal portion 181. In this way, in comparison to a state where the above described differential pressure is absent, the sealing performance of the packing portion 241 against the first main-body seal portion 181 is improved.

This is also the case where the packing portion 241 is positioned at the second predetermined position in response to the rotation of the controller member 22. Specifically, in the case where the packing portion 241 is positioned at the second predetermined position, the valve chamber internal pressure becomes higher than the second outflow hole internal pressure, as discussed above. Therefore, in the case where the packing portion 241 is positioned at the second predetermined position, the packing portion 241 is urged against the second main-body seal portion 201 by the valve chamber internal pressure. Specifically, the packing portion 241 is urged against the second main-body seal portion 201 by a differential pressure between the second outflow hole internal pressure and the valve chamber internal pressure, so that the packing portion 241 closely contacts the second main-body seal portion 201. Thereby, in comparison to the state where the differential pressure discussed above is absent, the sealing performance of the packing portion 241 against the second main-body seal portion 201 is improved.

Furthermore, the urging force, which urges the packing portion 241 against the first main-body seal portion 181 or the second main-body seal portion 201, changes in response to the flow rate and the pressure of the flowing fluid that is circulated. In this regard, since the inflow hole 12b is connected to, for example, the pump, the urging force against the packing portion 241 is increased when the flow rate of the flowing fluid, which is inputted from the inflow hole 12b, is increased. Therefore, when the flow rate of the flowing fluid is increased, the packing portion 241 can seal against the first main-body seal portion 181 and the second main-body seal portion 201 with a stronger force.

Furthermore, although the rotational drive force, which drives the rotatable portion 221 to rotate, is changed in response to a change in the urging force against the packing portion 241, it is not necessary to wastefully increase the rotational drive force since the urging force against the packing portion 241 is changed in response to a change in the flow rate of the flowing fluid.

As discussed above, although the packing portion 241 is configured to be urged against each of the first main-body seal portion 181 and the second main-body seal portion 201, the surface of the packing portion 241, which is urged against the first main-body seal portion 181 or the second main-body seal portion 201, has a protrusion and a recess, as shown in FIGS. 3 and 5. Specifically, the packing portion 241 includes a packing seal portion 241b, a packing seal inside portion 241c and a packing recess 241d, which are placed at an outside of the packing portion 241 in the valve radial direction DRr.

In the case where the packing portion 241 is positioned at the first predetermined position, the packing seal portion 241b is opposed to and is urged against the first main-body seal portion 181, and the packing seal inside portion 241c is opposed to and is urged against the first seal inside portion 182. Similarly, in the case where the packing portion 241 is positioned at the second predetermined position, the packing seal portion 241b is opposed to and is urged against the second main-body seal portion 201, and the packing seal inside portion 241c is opposed to and is urged against the second seal inside portion 202.

The packing seal portion 241b faces the outer side in the valve radial direction DRr and is shaped into the ring form. When the packing portion 241 is positioned at the first predetermined position, the packing seal portion 241b contacts the first main-body seal portion 181 along an entire length of the first main-body seal portion 181. When the packing portion 241 is positioned at the second predetermined position, the packing seal portion 241b contacts the second main-body seal portion 201 along an entire length of the second main-body seal portion 201.

Furthermore, the packing seal inside portion 241c is placed on the inner side of the packing seal portion 241b and extends in the valve circumferential direction DRc.

The packing recess 241d is placed on the inner side of the packing seal portion 241b and is inwardly recessed relative to the packing seal portion 241b and the packing seal inside portion 241c in the valve radial direction DRr. The packing recess 241d is divided into two parts in the valve axial direction DRa by the packing seal inside portion 241c.

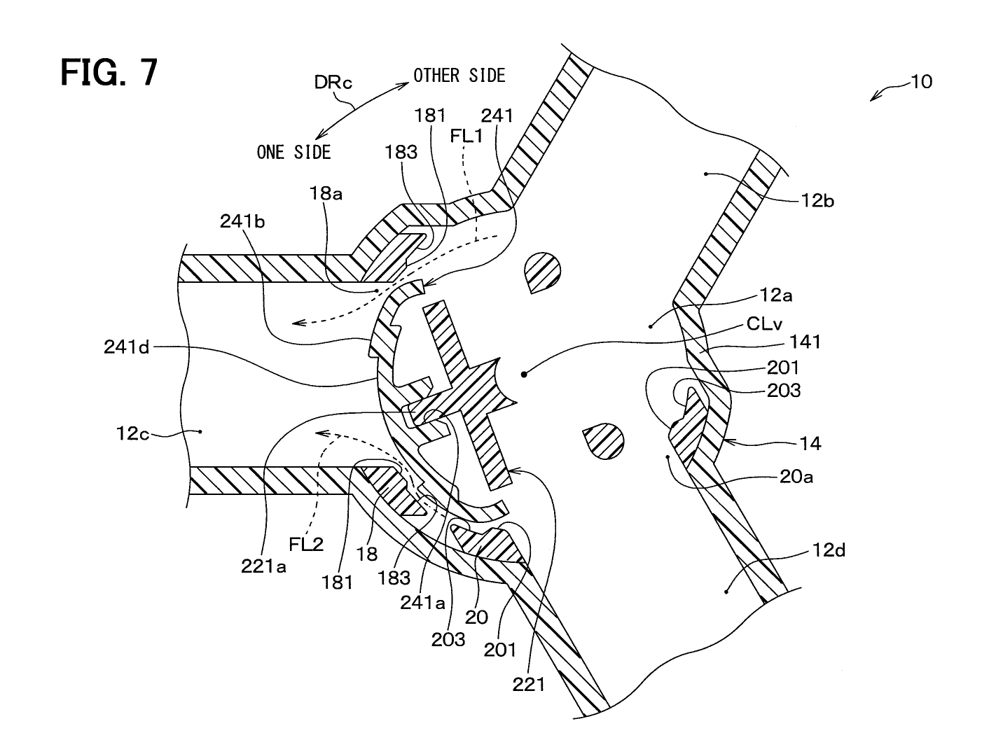

As shown in FIGS. 4 and 7, the first main-body seal portion 181 and the second main-body seal portion 201 are respectively shaped in a form of projection that inwardly projects in the valve radial direction DRr at the valve-chamber outer peripheral portion 121. Therefore, in a case where the first main-body seal portion 181 is seen as a reference point, the portion, which is adjacent to the first main-body seal portion 181 and extends around the first main-body seal portion 181, is outwardly recessed relative to the first main-body seal portion 181 in the valve radial direction DRr. Furthermore, in a case where the second main-body seal portion 201 is seen as a reference point, the portion, which is adjacent to the second main-body seal portion 201 and extends around the second main-body seal portion 201, is outwardly recessed relative to the second main-body seal portion 201 in the valve radial direction DRr.

Specifically, at the valve-chamber outer peripheral portion 121, the first seal member 18 includes a first main-body recess 183, which is outwardly recessed relative to the first main-body seal portion 181 in the valve radial direction DRr, and the first main-body recess 183 is placed at the inside of the first seal member 18 in the valve radial direction DRr. Similarly, at the valve-chamber outer peripheral portion 121, the second seal member 20 includes a second main-body recess 203, which is outwardly recessed relative to the second main-body seal portion 201 in the valve radial direction DRr, and the second main-body recess 203 is placed at the inside of the second seal member 20 in the valve radial direction DRr. Here, it should be understood that the portions, which are not shown in the cross section in FIG. 7, are omitted for the sake of easy understanding.

As shown in FIG. 7, at the valve-chamber outer peripheral portion 121, the first main-body recess 183 and the second main-body recess 203 are connected relative to each other and form one main-body recess that is formed at the inside of the valve-chamber outer peripheral portion 121 in the valve radial direction DRr.

Furthermore, the first main-body recess 183 is formed around the first main-body seal portion 181 and is thereby placed adjacent to the first main-body seal portion 181. For example, the first main-body recess 183 is placed on one side and the other side of the first main-body seal portion 181 in the valve circumferential direction DRc.

Similarly, the second main-body recess 203 is formed around the second main-body seal portion 201 and is thereby placed adjacent to the second main-body seal portion 201. For example, the second main-body recess 203 is placed on one side and the other side of the second main-body seal portion 201 in the valve circumferential direction DRc.

Here, at the time of rotating the packing portion 241, which is in the first predetermined position, to the second predetermined position, the rotatable portion 221 of the controller member 22 drives the packing portion 241 to rotate from the first predetermined position toward the one side in the valve circumferential direction DRc, and thereby the first outflow-hole opening end 18a is opened. At the time of opening the first outflow-hole opening end 18a from the closed state, a first gap is formed between the first main-body seal portion 181 and the packing portion 241 at the other side of the packing portion 241 in the valve circumferential direction DRc. In other words, the first gap is formed at the other circumferential side end of the first outflow-hole opening end 18a, which is located at the other side in the valve circumferential direction DRc. Then, the flowing fluid in the valve chamber 12a flows into the first outflow hole 12c through the first gap as indicated by an arrow FL1.

Furthermore, due to the provision of the first main-body recess 183 and the packing recess 241d, a second gap is formed between the first main-body seal portion 181 and the packing portion 241 at the one circumferential side end of the first outflow-hole opening end 18a, which is located on the one side in the valve circumferential direction DRc, besides the first gap. Therefore, the flowing fluid in the valve chamber 12a flows into the first outflow hole 12c as indicated by the arrow FL1 and also flows into the first outflow hole 12c through the second gap as indicated by an arrow FL2.

Specifically, at the time of opening the first outflow-hole opening end 18a from the closed state, the first outflow-hole opening end 18a is opened while the flows of the flowing fluid, which respectively flow through the first gap and the second gap, are generated as indicated by the arrows FL1, FL2. This phenomenon occurs not only in the case, in which the packing portion 241 is rotated from the first predetermined position toward the one side in the valve circumferential direction DRc, but also in another case, in which the packing portion 241 is rotated from the first predetermined position toward the other side in the valve circumferential direction DRc. This phenomenon also occurs in a case, in which the packing portion 241 is rotated from the second predetermined position toward the one side in the valve circumferential direction DRc, and in another case, in which the packing portion 241 is rotated from the second predetermined position toward the other side in the valve circumferential direction DRc.

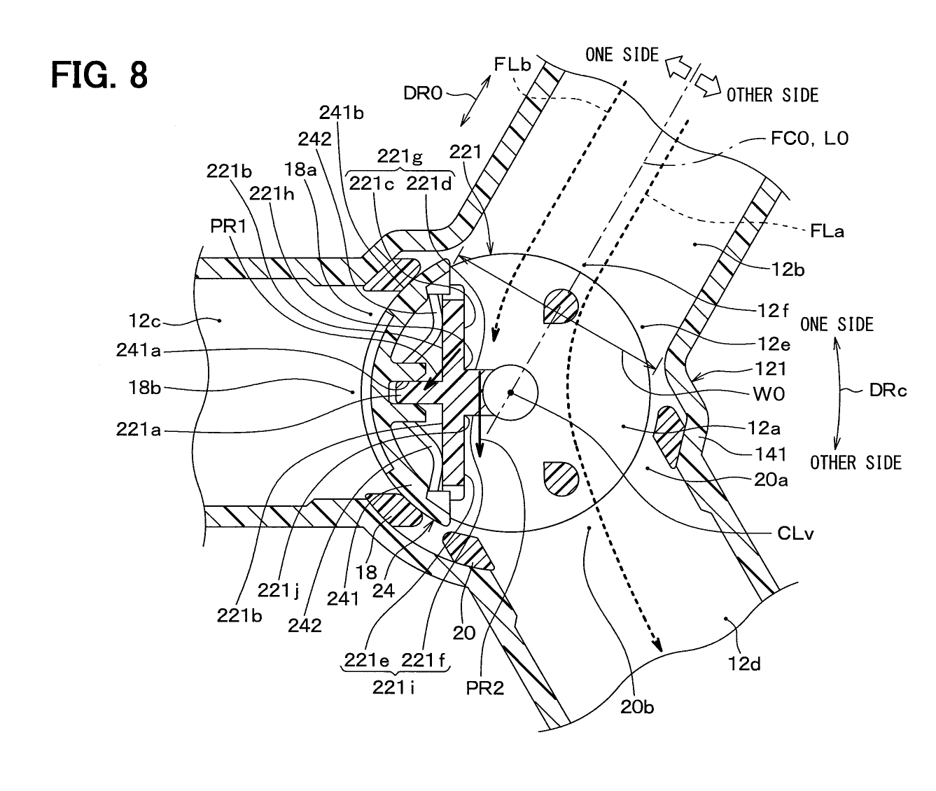

As shown in FIG. 8, the inflow hole 12b and the two outflow holes 12c, 12d are arranged one after the other at equal intervals in the valve circumferential direction DRc. Therefore, in a case where an imaginary center plane FC0, which includes the valve axis CLv and extends through a center 12f of the inflow-hole opening end 12e, is assumed to be present, a center 18b of the first outflow-hole opening end 18a is placed on the one side of the imaginary center plane FC0. Furthermore, a center 20b of the second outflow-hole opening end 20a is placed on the other side of the imaginary center plane FC0.

Furthermore, the rotatable portion 221 of the controller member 22 includes a first pressure receiving surface 221c, a second pressure receiving surface 221d, a third pressure receiving surface 221e and a fourth pressure receiving surface 221f. These pressure receiving surfaces 221c-221f are respectively formed as planar surfaces that extend in the valve axial direction DRa.

Furthermore, the first pressure receiving surface 221c is tilted relative to and is joined to the second pressure receiving surface 221d, and the first pressure receiving surface 221c and the second pressure receiving surface 221d form a first recess 221g that is recessed in the valve circumferential direction DRc. For example, the first recess 221g is recessed in a V-shape form in a cross section that is perpendicular to the valve axial direction DRa.

The first recess 221g is placed at a location that is displaced from the valve axis CLv in the valve radial direction DRr. The first recess 221g has a first recess bottom portion 221h that is most recessed at the first recess 221g and is located at a connection between the first pressure receiving surface 221c and the second pressure receiving surface 221d.

Similar to this, the third pressure receiving surface 221e is tilted relative to and is joined to the fourth pressure receiving surface 221f, and the third pressure receiving surface 221e and the fourth pressure receiving surface 221f form a second recess 221i that is recessed in the valve circumferential direction DRc. For example, the second recess 221i is recessed in a V-shape form like the first recess 221g.

The second recess 221i is placed at a location that is displaced from the valve axis CLv in the valve radial direction DRr. The second recess 221i is recessed in an opposite direction, which is opposite from that of the first recess 221g in the valve circumferential direction DRc. The second recess 221i has a second recess bottom portion 221j that is most recessed at the second recess 221i and is located at a connection between the third pressure receiving surface 221e and the fourth pressure receiving surface 221f.

For example, for a purpose of indicating an orientation of the inflow hole 12b, an imaginary line segment L0 of FIG. 8 is assumed to be present. In such a case, the inflow hole 12b is connected to the valve chamber 12a along the imaginary line segment L0. As shown in FIG. 8, in the first predetermined-position state, in which the packing portion 241 is positioned at the first predetermined position, the first recess 221g is recessed toward the opposite side that is opposite from the inflow-hole opening end 12e in the axial direction DR0 of the imaginary line segment L0. In addition, in the first predetermined-position state, the first recess bottom portion 221h overlaps with the inflow-hole opening end 12e in the axial direction DR0 of the imaginary line segment L0. Specifically, in the first predetermined-position state, when the inflow-hole opening end 12e is projected over the first recess 221g in the axial direction DR0 of the imaginary line segment L0, the inflow-hole opening end 12e is projected such that the inflow-hole opening end 12e has its extent W0 shown in FIG. 8. Thereby, the first recess bottom portion 221h overlaps with the projected inflow-hole opening end 12e.

Furthermore, in a second predetermined-position state where the packing portion 241 is positioned at the second predetermined position, the second recess 221i is recessed toward the opposite side that is opposite from the inflow-hole opening end 12e in the axial direction DR0 of the imaginary line segment L0. In addition, in the second predetermined-position state, the second recess bottom portion 221j overlaps with the inflow-hole opening end 12e in the axial direction DR0 of the imaginary line segment L0. Specifically, in the second predetermined-position state, when the inflow-hole opening end 12e is projected over the second recess 221i in the axial direction DR0 of the imaginary line segment L0, the second recess bottom portion 221j overlaps with the projected inflow-hole opening end 12e.

The following point can be understood based on the positional relationship between the inflow-hole opening end 12e and each recess 221g, 221i discussed above. Specifically, when the rotatable portion 221 drives the packing portion 241 to rotate from the first predetermined position in the counterclockwise direction (i.e., toward the one side in the valve circumferential direction DRc) in FIG. 8, the first outflow-hole opening end 18a is opened while the packing portion 241 is moved toward the second predetermined position. The rotation of the packing portion 241 from the first predetermined position in the counterclockwise direction in FIG. 8 results in the rotation of the packing portion 241 from the first predetermined position toward the side, toward which the first recess 221g is moved away from the inflow-hole opening end 12e in the valve circumferential direction DRc upon the rotation of the packing portion 241.

Furthermore, when the rotatable portion 221 drives the packing portion 241 to rotate from the second predetermined position in the clockwise direction (i.e., toward the other side in the valve circumferential direction DRc) in FIG. 8, the second outflow-hole opening end 20a is opened while the packing portion 241 is moved toward the first predetermined position. The rotation of the packing portion 241 from the second predetermined position in the clockwise direction in FIG. 8 results in the rotation of the packing portion 241 from the second predetermined position toward the side, toward which the second recess 221i is moved away from the inflow-hole opening end 12e in the valve circumferential direction DRc upon the rotation of the packing portion 241.

For example, in the case where the packing portion 241 is in the first predetermined position, the first recess 221g receives the flow of the flowing fluid, which flows from the inflow hole 12b into the valve chamber 12a as indicated by the arrows FLa, FLb. Therefore, the first recess 221g converts a dynamic pressure of the flowing fluid applied to the first recess 221g into a rotational force (e.g., forces indicated by arrows PR1, PR2) that rotates the rotatable portion 221 in the counterclockwise direction in FIG. 8. Specifically, at the time of starting the rotation of the packing portion 241 from the first predetermined position in the counterclockwise direction in FIG. 8 through the rotation of the rotatable portion 221, the rotation of the rotatable portion 221 is assisted by the flow of the flowing fluid. Therefore, at the time of starting the rotation from the first predetermined position, it is possible to reduce a required rotational drive force, which is required to be applied from the drive source of the rotatable portion 221 to the rotatable portion 221.

Furthermore, as discussed above, when the flow rate of the flowing fluid, which is inputted from the inflow hole 12b, is increased, the urging force applied to the packing portion 241 is increased. Therefore, the rotatable portion 221 needs to be rotated by the large rotational drive force. In contrast, the assist force of the flowing fluid, which assists the rotation of the rotatable portion 221, is increased in response to an increase in the flow rate of the flowing fluid, so that it is not necessary to wastefully increase the rotational drive force exerted from the drive source of the rotatable portion 221.

Furthermore, similar to the case where the packing portion 241 is in the first predetermined position, in the case where the packing portion 241 is in the second predetermined position, the second recess 221i receives the flow of the flowing fluid, which flows from the inflow hole 12b into the valve chamber 12a. Therefore, at the time of starting the rotation of the packing portion 241 from the second position in the clockwise direction in FIG. 8 through the rotation of the rotatable portion 221, it is possible to reduce the required rotational drive force, which needs to be applied from the drive source of the rotatable portion 221 to the rotatable portion 221.

Furthermore, since the first recess 221g is recessed in the above-described manner, it is possible to increase the rotational force that assists the rotation of the rotatable portion 221 in comparison to a structure, in which the first recess 221g is replaced to have, for example, a planar shape. This is also true with respect to the advantage of the second recess 221i.

As discussed above, in the present embodiment, in the case where the packing portion 241 is positioned at the first predetermined position, at which the packing portion 241 closes the first outflow-hole opening end 18a, as shown in FIG. 2, the packing portion 241 is urged against the first main-body seal portion 181 in the valve radial direction DRr by the pressure of the flowing fluid in the valve chamber 12a, which is higher than the pressure in the first outflow hole 12c. Specifically, the urging force, which urges the packing portion 241 against the first main-body seal portion 181 at the time of closing the first outflow-hole opening end 18a, is not increased or decreased in response to the resilient deformation of the packing portion 241.

Therefore, it is less necessary to consider the variations or the deteriorations of the respective components (e.g., the packing portion 241) to avoid the decrease in the urging force. Thus, it is not required to wastefully increase the rotational drive force that rotates the rotatable portion 221 and the packing portion 241. This is also true for the case where the packing portion 241 is positioned at the second predetermined position, in which the packing portion 241 closes the second outflow-hole opening end 20a.

Furthermore, according to the present embodiment, as shown in FIG. 7, at the time of rotating the packing portion 241, which is in the first predetermined position, to the second predetermined position, the rotatable portion 221 drives the packing portion 241 to rotate from the first predetermined position toward the one side in the valve circumferential direction DRc, and thereby the first outflow-hole opening end 18a is opened. The first main-body recess 183 is placed adjacent to the first main-body seal portion 181 and is placed at least on the one side of the first main-body seal portion 181 in the valve circumferential direction DRc. The packing recess 241d is placed on the inner side of the packing seal portion 241b, which is shaped into the ring form.

Therefore, at the minute opening time of the first outflow-hole opening end 18a, during which the first outflow-hole opening end 18a is slightly opened by rotating the packing portion 241 from the first predetermined position toward the one side in the valve circumferential direction DRc, the flow of the flowing fluid from the valve chamber 12a to the first outflow hole 12c is generated as indicated by the arrows FL1, FL2. Specifically, the flow of the flowing fluid is generated not only at the other circumferential side end of the first outflow-hole opening end 18a, which is located at the other side in the valve circumferential direction DRc, but also at the one circumferential side end of the first outflow-hole opening end 18a, which is located at the one side in the valve circumferential direction DRc.

In this way, the flow velocity of the flowing fluid, which flows from the valve chamber into the first outflow hole 12c, can be reduced in comparison to the case where the flow of the flowing fluid is generated only at the other circumferential side end of the first outflow-hole opening end 18a. Therefore, it is possible to limit the action of the flow of the flowing fluid, which outwardly urges the packing portion 241 in the valve radial direction DRr at the minute opening time. This is also true at the minute opening time of the second outflow-hole opening end 20a, during which the second outflow-hole opening end 20a is slightly opened by rotating the packing portion 241 from the second predetermined position toward the other side in the valve circumferential direction DRc.

Furthermore, according to the present embodiment, as shown in FIGS. 5 and 6, the urging portion 242 of the packing member 24 is rotated about the valve axis CLv together with the controller member 22 and outwardly urges the packing portion 241 in the valve radial direction DRr. Therefore, in the case where the packing portion 241 is positioned at the first predetermined position, it is possible to easily generate the differential pressure between the inside and the outside of the packing portion 241 in the valve radial direction DRr. As a result, for example, the action of urging the packing portion 241 against the first main-body seal portion 181 can be enhanced in the case where the packing portion 241 is positioned at the first predetermined position. This is also true in the case where the packing portion 241 is positioned at the second predetermined position.

The urging force, which is exerted from the urging portion 242 to outwardly urge the packing portion 241 in the valve radial direction DRr, does not need to act as a seal force for sealing the first outflow hole 12c or the second outflow hole 12d at the time of fully closing the first outflow hole 12c or the second outflow hole 12d. It would suffice if the urging force of the urging portion 242 makes the packing seal portion 241b to contact the corresponding one of the first main-body seal portion 181 or the second main-body seal portion 201. In view of this, it is desirable to construct the urging portion 242 such that the urging force of the urging portion 242 is minimized.

According to the present embodiment, as shown in FIG. 8, the first recess bottom portion 221h overlaps the inflow-hole opening end 12e in the axial direction DR0 of the imaginary line segment L0 in the first predetermined-position state, in which the packing portion 241 is positioned at the first predetermined position. Thus, the first recess bottom portion 221h can be positioned such that the generation of the rotational force, which assists the rotation of the rotatable portion 221, is facilitated through application of the dynamic pressure of the fluid to the first recess bottom portion 221h at the time of starting the rotation of the packing portion 241 from the first predetermined position in the counterclockwise direction in FIG. 8 through the rotation of the rotatable portion 221. This is also true for the second recess 221i.

Furthermore, according to the present embodiment, as shown in FIGS. 2 and 8, the rotatable portion 221 supports the packing portion 241 in such a manner that the relative movement of the packing portion 241 relative to the rotatable portion 221 in the valve radial direction DRr is enabled. Therefore, the packing portion 241 can be supported without interfering with the closing action of the packing portion 241 for closing each of the outflow holes 12c, 12d.

Furthermore, according to the present embodiment, the rotatable portion 221 has the flow rate adjusting function for each of the outflow holes 12c, 12d, and the packing portion 241 has the seal function for each of the outflow holes 12c, 12d. Therefore, the rotatable portion 221 implements the flow rate adjustment at intermediate opening degrees between the full closing time of the first outflow hole 12c (i.e., the first predetermined-position state) and the full closing time of the second outflow hole 12d (i.e., the second predetermined-position state). In contrast, the sealing of the first outflow-hole opening end 18a at the full closing time of the first outflow hole 12c is implemented by strongly urging the packing portion 241 against the first main-body seal portion 181. Similarly, the sealing of the second outflow-hole opening end 20a at the full closing time of the second outflow hole 12d is implemented by strongly urging the packing portion 241 against the second main-body seal portion 201.

Furthermore, at the intermediate opening degrees discussed above, the differential pressure force exerted between the inside and the outside of the packing portion 241 in the valve radial direction DRr is reduced in comparison to the full closing time discussed above, so that the urging force, which urges the packing portion 241 against the first main-body seal portion 181 or the second main-body seal portion 201, is reduced. Thus, the rotational drive force, which rotates the rotatable portion 221, can be reduced, and the wearing of the packing portion 241 can be reduced.

### Other Embodiments

(1) In the above embodiment, the valve main body 12 includes the body member 14, the cover member 16 and the two seal members 18, 20. With respect to this configuration, since the cover member 16 and the two seal members 18, 20 are all fixed to the body member 14, the cover member 16 and/or the two seal members 18, 20 may be integrally formed with the body member 14 in one piece as long as the flow path switching valve 10 can be assembled. For example, the two seal members 18, 20 and the body member 14 may be integrally formed in one piece as one component.

(2) In the above embodiment, although the flow path switching valve 10 is the three-way valve, the number of the connection ports of the flow path switching valve 10 should not be limited to any particular number. For example, the flow path switching valve 10 may be a rotary opening/closing valve (i.e., a shutoff valve) that includes only one of the two outflow holes 12c, 12d and opens and closes the flow path. In short, the flow path switching valve is a concept that encompasses not only the three-way valve but also the two-way valve.

(3) In the above embodiment, although the flowing fluid of the flow path switching valve 10 is the liquid, gas may be used as the flowing fluid of the flow path switching valve 10.

(4) In the above embodiment, although the packing portion 241 and the urging portion 242 are formed integrally in one piece as the one component, the packing portion 241 and the urging portion 242 may be formed separately as separate components. Furthermore, the packing portion 241 is not necessarily made of the resin. For example, the packing portion 241 may be made of elastomer, such as rubber. Furthermore, the urging portion 242 is not necessarily made of the resin. For example, the urging portion 242 may be made of a coil spring or a plate spring.

(5) In the above embodiment, for example, the inflow hole 12b is connected to the discharge outlet of the pump, and the first outflow hole 12c is connected to the suction inlet of the pump through the first supply subject device, and the second outflow hole 12d is connected to the suction inlet of the pump through the second supply subject device. However, this is only one example, and the connecting subjects of the inflow hole 12b and the outflow holes 12c, 12d are not necessarily limited to any particular ones as long as the valve chamber internal pressure is higher than the internal pressure of one of the first outflow hole 12c and the second outflow hole 12d, which is closed by the packing portion 241.

(6) In the above embodiment, as shown in FIG. 4, the first main-body seal portion 181 is formed as a partial form at the inside of the valve-chamber outer peripheral portion 121 in the valve radial direction DRr and is formed as the projecting part that is partially projected. However, this is the one example. For example, the first main-body recess 183 may be formed as a partial form at the inside of the valve-chamber outer peripheral portion 121 in the valve radial direction DRr and may be formed as a recessed part that is partially recessed. That is, as long as the first main-body recess 183 is outwardly recessed in the valve radial direction DRr relative to the first main-body seal portion 181, it does not matter which part is formed as the partial form. This is also true with respect to the relationship between the second main-body seal portion 201 and the second main-body recess 203.

This is also true with respect to the relationship between the packing seal portion 241b and the packing recess 241d of the packing portion 241 of FIG. 5. That is, as long as the packing recess 241d is inwardly recessed in the valve radial direction DRr relative to the packing seal portion 241b, it does not matter which one of the packing seal portion 241b and the packing recess 241d of the packing portion 241 is shaped into the partial form.

(7) In the above embodiment, as shown in FIGS. 2 and 3, the engaging portion 221a of the rotatable portion 221 is shaped into the plate form. However, this is the one example. For example, the engaging portion 221a may be shaped into a boss form, i.e., a cylindrical columnar form that outwardly projects in the radial direction DRr. In such a case, when the packing member 24 is urged against the first main-body seal portion 181 or the second main-body seal portion 201, the orientation of the packing member 24 is set such that the packing seal portion 241b is fitted along the curved surface of the main-body seal portion 181, 201 that inwardly faces in the valve radial direction DRr.

The present disclosure should not be limited to the above embodiments. The present disclosure encompasses various modifications and variations within the equivalent scope. The constituent element(s) of each of the above embodiments is/are not necessarily essential unless it is specifically stated that the constituent element(s) is/are essential in the above embodiment, or unless the constituent element(s) is/are obviously essential in principle.

Furthermore, in each of the above embodiments, in the case where the number of the constituent element(s), the value, the amount, the range, and/or the like is specified, the present disclosure is not necessarily limited to the number of the constituent element(s), the value, the amount, and/or the like specified in the embodiment unless the number of the constituent element(s), the value, the amount, and/or the like is indicated as indispensable or is obviously indispensable in view of the principle of the present disclosure. Furthermore, in each of the above embodiments, in the case where the material, the shape and/or the positional relationship of the constituent element(s) are specified, the present disclosure is not necessarily limited to the material, the shape and/or the positional relationship of the constituent element(s) unless the embodiment specifically states that the material, the shape and/or the positional relationship of the constituent element(s) is/are essential or is/are obviously essential in principle.

### SUMMARY

According to a first aspect indicated at a portion or a whole of the above embodiment, the packing portion is configured to be positioned at the predetermined position, at which the packing portion closes the outflow-hole opening end, in response to rotation of the rotatable portion. The packing portion is configured to be urged against the main-body seal portion in the radial direction of the valve axis by the pressure of the fluid in the valve chamber, which is higher than the pressure in the outflow hole, when the packing portion is positioned at the predetermined position.

Furthermore, according to a second aspect, the valve-chamber outer peripheral portion includes the main-body recess that is placed at the inside of the valve-chamber outer peripheral portion in the radial direction and is recessed in the radial direction relative to the main-body seal portion. The main-body recess is placed adjacent to the main-body seal portion on the one side of the main-body seal portion in the circumferential direction of the valve axis. The packing portion includes: the packing seal portion that is configured to be opposed to and urged against the main-body seal portion at the predetermined portion; and the packing recess that is placed at the inside of the packing seal portion and is recessed from the packing seal portion in the radial direction while the packing seal portion and the packing recess are placed at the outside of the packing portion in the radial direction. Therefore, at the minute opening time of the outflow-hole opening end, during which the outflow-hole opening end is slightly opened by rotating the packing portion from the predetermined position toward the one side in the circumferential direction, the flow of the flowing fluid from the valve chamber to the outflow hole is generated not only at the other circumferential side end of the outflow-hole opening end but also at the one circumferential side end of the outflow-hole opening end. In this way, the flow velocity of the flowing fluid, which flows from the valve chamber into the outflow hole, can be reduced in comparison to the case where the flow of the flowing fluid is generated only at the other circumferential side end of the outflow-hole opening end. Therefore, it is possible to limit the action of the flow of the flowing fluid, which outwardly urges the packing portion in the radial direction at the minute opening time.

Furthermore, according to a third aspect, the flow path switching valve includes the urging portion that is configured to be rotatable about the valve axis together with the rotatable portion and the packing portion. The urging portion is configured to outwardly urge the packing portion in the radial direction. Therefore, in the case where the packing portion is positioned at the predetermined position, it is possible to easily generate the differential pressure between the inside (i.e., the inside of the valve chamber) and the outside (i.e., the inside of the outflow hole) of the packing portion in the radial direction. As a result, for example, the action of urging the packing portion against the main-body seal portion can be enhanced in the case where the packing portion is positioned at the predetermined position.

Furthermore, according to a fourth aspect, the inflow hole is connected to the valve chamber along the imaginary line segment. The recess of the rotatable portion is recessed toward the opposite side, which is opposite from the inflow-hole opening end in the axial direction of the imaginary line segment, in the predetermined-position state where the packing portion is positioned at the predetermined position. The recess is located at the position that is displaced from the valve axis in the radial direction. The rotatable portion is configured to open the outflow-hole opening end by rotating the packing portion from the predetermined position toward the side, toward which the recess is moved away from the inflow-hole opening end in the circumferential direction of the valve axis upon the rotating of the packing portion. Therefore, at the predetermined position of the packing portion, the recess of the rotatable portion receives the fluid, which flows into the valve chamber through the inflow hole. Thus, at the time of starting the rotation, at which the rotatable portion begins to rotate the packing portion from the predetermined position, the rotation of the rotatable portion is assisted by the dynamic pressure of the fluid, which is received by the recess of the rotatable portion. Therefore, at the time of starting the rotation from the predetermined position, it is possible to reduce the required rotational drive force, which is required to be applied from the drive source of the rotatable portion to the rotatable portion.

Furthermore, according to a fifth aspect, the bottom portion of the recess, which is recessed deepest at the recess, overlaps with the inflow-hole opening end in the axial direction of the imaginary line segment in the predetermined-position state. Thus, the recess can be positioned such that the generation of the rotational force, which assists the rotation of the rotatable portion, is facilitated through application of the dynamic pressure of the fluid to the recess at the time of starting the rotation of the rotatable portion.

According to a sixth aspect, the rotatable portion is configured to open the first outflow-hole opening end while moving the packing portion toward the second predetermined position by rotating the packing portion from the first predetermined position toward the side, toward which the first recess is moved away from the inflow-hole opening end in the circumferential direction of the valve axis upon the rotating of the packing portion. Furthermore, the rotatable portion is configured to open the second outflow-hole opening end while moving the packing portion toward the first predetermined position by rotating the packing portion from the second predetermined position toward the side, toward which the second recess is moved away from the inflow-hole opening end in the circumferential direction of the valve axis upon the rotating of the packing portion. Thus, advantages, which are similar to the advantages that can be obtained according to the fourth aspect, can be obtained with the flow path switching valve that has the first outflow hole and the second outflow hole.

Furthermore, according to a seventh aspect, the bottom portion of the first recess, which is recessed deepest at the first recess, is positioned to overlap with the inflow-hole opening end in the axial direction of the imaginary line segment in the first predetermined-position state where the packing portion is positioned at the first predetermined position. Furthermore, the bottom portion of the second recess, which is recessed deepest at the second recess, is positioned to overlap with the inflow-hole opening end in the axial direction of the imaginary line segment in the second predetermined-position state where the packing portion is positioned at the second predetermined position. Thus, advantages, which are similar to the advantages that can be obtained according to the fifth aspect, can be obtained with the flow path switching valve that has the first outflow hole and the second outflow hole.

Furthermore, according to an eighth aspect, the rotatable portion supports the packing portion in a manner that enables relative movement of the packing portion relative to the rotatable portion in the radial direction. Therefore, the packing portion can be supported without interfering with the closing action of the packing portion for closing the outflow hole.

What is claimed is:

1. A flow path switching valve that is a rotary valve and is configured to switch a flow path, through which fluid flows, or to open and close the flow path, comprising:
a rotatable portion that is configured to rotate about a valve axis;
a packing portion that is supported by the rotatable portion while the packing portion is not rotatable relative to the rotatable portion; and
a valve main body that includes:
a valve chamber that receives the rotatable portion and the packing portion;
an inflow hole that is communicated with the valve chamber and is configured to input the fluid into the valve chamber; and
an outflow hole that is communicated with the valve chamber and is configured to output the fluid from the valve chamber, wherein:
the valve main body includes a valve-chamber outer peripheral portion that surrounds the valve chamber about the valve axis;
the outflow hole has an outflow-hole opening end that is opened to the valve chamber at a part of the valve-chamber outer peripheral portion;
the valve-chamber outer peripheral portion includes a main-body seal portion that extends to surround the outflow-hole opening end and is exposed in an inside of the valve chamber;
the packing portion is configured to be positioned at a predetermined position, at which the packing portion closes the outflow-hole opening end, in response to rotation of the rotatable portion; and
the packing portion is configured to be urged against the main-body seal portion in a radial direction of the valve axis by a pressure of the fluid in the valve chamber, which is higher than a pressure in the outflow hole, when the packing portion is positioned at the predetermined position.

2. The flow path switching valve according to claim 1, wherein:
the rotatable portion is configured to open the outflow-hole opening end by rotating the packing portion from the predetermined position toward one side in a circumferential direction of the valve axis;
the valve-chamber outer peripheral portion includes a main-body recess that is placed at an inside of the valve-chamber outer peripheral portion in the radial direction and is recessed in the radial direction relative to the main-body seal portion;
the main-body recess is placed adjacent to the main-body seal portion on the one side of the main-body seal portion in the circumferential direction of the valve axis; and
the packing portion includes:
a packing seal portion that is configured to be opposed to and urged against the main-body seal portion at the predetermined portion; and
a packing recess that is placed at an inside of the packing seal portion and is recessed from the packing seal portion in the radial direction while the packing seal portion and the packing recess are placed at an outside of the packing portion in the radial direction.

3. The flow path switching valve according to claim 1, comprising an urging portion that is configured to be rotatable about the valve axis together with the rotatable portion and the packing portion, wherein the urging portion is configured to outwardly urge the packing portion in the radial direction.

4. The flow path switching valve according to claim 1, wherein:
the inflow hole has an inflow-hole opening end that is opened to the valve chamber at a location of the valve-chamber outer peripheral portion, which is different from a location of the outflow hole, while the inflow hole is connected to the valve chamber along an imaginary line segment;
the rotatable portion includes a recess that is recessed toward an opposite side, which is opposite from the inflow-hole opening end in an axial direction of the imaginary line segment, in a predetermined-position state where the packing portion is positioned at the predetermined position;
the recess is located at a position that is displaced from the valve axis in the radial direction; and
the rotatable portion is configured to open the outflow-hole opening end by rotating the packing portion from the predetermined position toward a side, toward which the recess is moved away from the inflow-hole opening end in the circumferential direction of the valve axis upon the rotating of the packing portion.

5. The flow path switching valve according to claim 4, wherein a bottom portion of the recess, which is recessed deepest at the recess, overlaps with the inflow-hole opening end in the axial direction of the imaginary line segment in the predetermined-position state.

6. The flow path switching valve according to claim 1, wherein:
besides the outflow hole, which is a first outflow hole, the valve main body includes a second outflow hole that is communicated with the valve chamber to output the fluid from the valve chamber;
the outflow-hole opening end is a first outflow-hole opening end;
the second outflow hole has a second outflow-hole opening end that is opened to the valve chamber at a location of the valve-chamber outer peripheral portion, which is different from a location of the first outflow hole;
the inflow hole has an inflow-hole opening end that is opened to the valve chamber at a location that is different from the location of the first outflow hole and the location of the second outflow hole at the valve-chamber outer peripheral portion while the inflow hole is connected to the valve chamber along an imaginary line segment;
a center of the first outflow-hole opening end is located on one side of an imaginary center plane that includes the valve axis and extends through a center of the inflow-hole opening end;
a center of the second outflow-hole opening end is located on another side of the imaginary center plane;
the packing portion is positionable at each of the predetermined position, which is a first predetermined position, and a second predetermined position, at which the packing portion closes the second outflow-hole opening end, in response to the rotation of the rotatable portion;
the rotatable portion includes:
a first recess that is recessed toward an opposite side that is opposite from the inflow-hole opening end in an axial direction of the imaginary line segment in a first predetermined-position state where the packing portion is positioned at the first predetermined position; and
a second recess that is recessed toward the opposite side that is opposite from the inflow-hole opening end in the axial direction of the imaginary line segment in a second predetermined-position state where the packing portion is positioned at the second predetermined position;
a position of the first recess and a position of the second recess are displaced from the valve axis in the radial direction;
the rotatable portion is configured to open the first outflow-hole opening end while moving the packing portion toward the second predetermined position by rotating the packing portion from the first predetermined position toward a side, toward which the first recess is moved away from the inflow-hole opening end in a circumferential direction of the valve axis upon the rotating of the packing portion; and
the rotatable portion is configured to open the second outflow-hole opening end while moving the packing portion toward the first predetermined position by rotating the packing portion from the second predetermined position toward a side, toward which the second recess is moved away from the inflow-hole opening end in the circumferential direction of the valve axis upon the rotating of the packing portion.

7. The flow path switching valve according to claim 6, wherein:
a bottom portion of the first recess, which is recessed deepest at the first recess, is positioned to overlap with the inflow-hole opening end in the axial direction of the imaginary line segment in the first predetermined-position state; and
a bottom portion of the second recess, which is recessed deepest at the second recess, is positioned to overlap with the inflow-hole opening end in the axial direction of the imaginary line segment in the second predetermined-position state.

8. The flow path switching valve according to claim 1, wherein the rotatable portion supports the packing portion in a manner that enables relative movement of the packing portion relative to the rotatable portion in the radial direction.
